(19) United States
(12) Patent Application Publication
(10) Pub. No.: US 2018/0142513 A1
(43) Pub. Date: May 24, 2018

(54) MODULAR PROFILE SYSTEM FOR SUSPENDING A DOOR OF A KITCHEN APPLIANCE

(71) Applicant: Electrolux Appliances Aktiebolag, Stockholm (SE)

(72) Inventors: Francesco Lampitelli, Forli (IT); Giorgio Pandini, Forli (IT)

(21) Appl. No.: 15/315,627

(22) PCT Filed: Jul. 24, 2015
(86) PCT No.: PCT/EP2015/067027

§ 371 Date: Dec. 1, 2016

(30) Foreign Application Priority Data
Jul. 24, 2014 (EP) 14178270.6

(51) Int. Cl. E06B 1/52; F24C 15/02; F24C 15/04

(52) U.S. Cl. CPC E06B 1/52; E06B 1/14; F24C 15/04; F24C 15/023

(57) ABSTRACT

A modular profile system (1) for suspending a door (2) of a kitchen appliance (3), comprising at least one elongate first profile element (4), at least one second profile element (5), and at least one panel element (7), wherein the at least one elongate first profile element (4) is formed to be attachable at its first longitudinal plane (10) to a surface (6) of a first panel element (7), and wherein the at least one elongate first profile element (4) is formed to be attachable at at least one of its end face (11) to said second profile element (5), wherein said second profile element (5) is selectable from a plurality of said second profile elements (5), wherein said elongate first profile element (4) is combinable and to be assembled with at least one particular of said plurality of second profile elements (5), in order to achieve and realize one particular door structure and/or door organization.

The present invention relates to a modular profile system and a door suspension for suspending a door of a kitchen appliance, a door for a kitchen appliance, comprising such modular system and/or door suspension, a kitchen appliance, comprising such door, door suspension and/or modular profile system and a profile element for a door of a kitchen appliance.

In kitchen appliances known in the prior art the door structure has to be changed and adapted to each configuration of desired application. For example, a door structure of a so called drop-down door, which is pivotally mounted about a horizontal axis and which opens downwards, substantially differs from a door structure of a swing door or side-opening door, which is pivotally mounted about a vertical axis and which opens sideways. In particular for such different door configurations the arrangement and configuration of structural elements, for example, of suspension profiles, door frame or hinges, also has to be completely different in order to fulfill the requirements for the different desired door configurations. Therefore, the use of one first configuration, e.g. a door and door structure configured for being hinged vertically, is not easily adaptable to the prerequisites of a second configuration, e.g. a door and door structure configured for being hinged horizontally. Accordingly, manufacturers usually provide a complete set of structural elements, particularly suspension profiles, door frames or hinges, each being completely different for each of the different provided door configurations.

Moreover, the number and configurations of structural elements and other parts used for each of such configuration varies and thus the manufacturing and assembly processes for different door configurations are completely different. For example, the inner door structure of a known side opening swing door is mainly formed by three parts, two profile elements, i.e. columns, at the left and right side of the door, preferably supporting the front glass panel and, usually a cover element. By contrast, the inner door structure of a known drop-down door is mainly formed by one substantially U-shaped profile element and two small parts for mounting the hinges, the small parts being mounted on or in the downside of the inner door structure. The glass panel is usually assembled in the structure of the door having at first a certain degree of freedom, whereby this degree is subsequently locked by the cover element in case of the swing door structure or the small parts mounted in the down side in case of the drop-down structure. It is obvious form the above that on the one hand a change from one first configuration to one second configuration is nearly synonymous to a total restructuring or in the majority of cases merely impossible, particularly where column elements are non-detachably fixed to the glass panel. On the other hand, each such configuration also limits the possibilities of variations of the aesthetic appearance, design and/or the materials of the door and, particularly of such inner door structure, and/or to change such aesthetic appearance, design and/or the materials of the door at the end of a manufacturing or assembly process.

The document DE 10 2005 033 225 A1 describes a door element of a door of a household appliance, wherein supporting profiles are detachably mounted to connecting means, wherein said connecting means are attached to a front glass panel and are for connecting the supporting profile to the front glass panel. Although such configuration allows for an exchange of the glass panel the flexibility in changing the overall door configuration, e.g. from mounting of a hinge for a drop-down door to a side opening door configuration is not possible.

It is an object of the present invention to provide a door, a door suspension or a door structure of a household appliance or means for the assembly thereof, which allows for an, preferably more easier, adaptation of the door structure to different door configurations, preferably at the end of a manufacturing and/or assembly process, more preferably if a door or door structure is already manufactured and/or assembled.

It is a still further object of the present invention to provide a door structure, a door suspension or a door of a household appliance allowing to change and/or adapt parts thereof in an easy way, which, preferably allows to vary the external shape and/or materials of such door or door structure, e.g. with regard to a skin and/or cover and/or the exchange of door structure elements by a door structure element of a different material.

The above objects of the invention are achieved in a first aspect by a modular profile system according to claim 1, in a second aspect by a door suspension for suspending a door of a kitchen appliance, in a third aspect by a door according to claim 13, in a fourth aspect by a kitchen appliance according to claim 14, and in a fifth aspect by a profile element according to claim 15.

A modular profile system according to claim 1 for suspending a door of a kitchen appliance comprises

at least one elongate first profile element,

at least one second profile element, and

at least one panel element,

wherein the at least one elongate first profile element is formed to be attachable at its first longitudinal plane to a surface of a first panel element, and

wherein the at least one elongate first profile element is formed to be attachable at at least one of its end faces, preferably its first and/or second end face to said or one particular second profile element, wherein said or the one particular second profile element is selectable and/or selected from a plurality of said second profile elements, wherein said elongate first profile element (4) is combinable and to be assembled with at least one particular of said plurality of second profile elements (5), in order to achieve and realize one particular door structure and/or door organization.

A door suspension according to the second aspect for suspending

a door of a kitchen appliance comprises

at least one elongate first profile element,

at least one second profile element, and

at least one panel element,

wherein the at least one elongate first profile element is attached and/or attachable at its first longitudinal plane to a surface of a first panel element, and

wherein the at least one elongate first profile element is attached and/or attachable at at least one of its end face, preferably its first end face to one particular second profile element selected from a plurality of said second profile elements,

wherein said elongate first profile element (4) is combinable and to be assembled with at least one particular of said plurality of second profile elements (5), in order to achieve and realize one particular door structure and/or door organization.

In a preferred embodiment the or a second profile element, which is selectable and/or selected from a plurality of said second profile elements, is attached to or formed to be attachable to at least one of the end face, preferably the first end face, of said elongate first profile element. Alternatively or additionally at least one further second profile element, which is also selectable and/or selected from a plurality of said second pros file elements, is attached to or formed to be attachable to a or the second end face of said elongate first profile element. In connection therewith it is important to understand that each second profile element is selectable and/or selected from said plurality of said second profile elements. Thus, the second prom file element may be same or different from the at least one further second profile element.

Such modular profile system and/or door suspension according to the present invention allows to create a modular door and/or door structure that can be used for and be easily adapted to all different types of doors, comprising side opening doors, e.g. swing doors or full doors, and drop-down doors. The modular profile system and/or door suspension according to the present invention further provides the possibility to create and/or to be adapted to a large number of door configurations. This is as each desired door structure to be realized, may be advantageously based on and realized with the modular profile system and/or door suspension according to the present invention, and more particularly with the at least one elongate first profile element being attachable at its first longitudinal plane to a surface of a first panel element, such as a surface of a planar panel element, e.g. planar glass panel. The elongate first profile element is also attachable at at least one of its end face, preferably its first end face, to at least one particular second profile element, wherein said at least one particular second profile element is selectable and/or selected from a plurality of said second profile elements, more particularly one second profile element appropriate for realizing a desired door structure and/or door configuration is selectable and/or selected from said plurality of second profile elements.

This is particularly the case as hinges or hinge elements may be applied to first profile elements and/or second profile elements, preferably to at least one particular second profile element, according to the present invention, depending on the desired configuration and the choice of the appropriate second profile element form a plurality of said second profile elements. Such plurality of second profile elements comprises second profile elements for various configurations and door structures and thus the door structure is easily adapted to a desired configuration by choosing the appropriate second profile element. For example, such second profile element may be configured in various ways, for pivotally hinged doors about a vertical or horizontal axis, e.g. for a side opening door or a drop-down door, respectively. Accordingly, the shape and further elements such as mounting points for hinges or hinge elements may or may not be present at such second profile element. At the same time, the elongate first profile element is preferably a door column, and is attachable at its first longitudinal plane to a surface of a first panel element, such as a glass panel, e.g. a front glass panel.

The modular profile system also particularly allows to select the first profile element manufactured from a first material and to assemble a second profile element selected from a plurality of said second profile elements manufactured from a second material. Thereby, the first and the second profile elements may be manufactured from the same or different material.

A profile element as used herein, thereby preferably is manufactured from a material selected from the group comprising plastic or metal. Is to be understood that according to the desired function and/or desired purpose the material may be selected accordingly. For example, plastic is used being a relatively cheap material, whereas metal may be used for doors of higher quality and price, so called premium doors.

It is to be understood that according to the present invention each first profile element is combined and assembled, or combinable and to be assembled with one particular second profile element out of the plurality of said second profile elements, in order to achieve and realize one particular door structure and/or door organization. Thereby, for example, a first profile element may be a plastic first profile element and can be assembled to a plurality of second profile elements having different shapes, but also particularly having different materials. For example, such plastic first profile element may be assembled to either a second profile element manufactured from plastic or to a second profile element being manufactured from metal.

In a further embodiment of the present invention the at least one elongate first profile element is formed to be attachable at its first end face, to at least one particular second profile element, wherein said at least one particular second profile element is selectable and/or selected from plurality of said second profile elements and at its second end face it is formed to be attachable to at least one particular second profile element, wherein said or the one particular second profile element is selectable and/or selected from a plurality of said second profile elements. Thus, the modular profile system and/or a door suspension according to the present invention may comprise at least one elongate first profile element attached to or formed to be attachable to two particular second profile elements, preferably one at each end face of the elongate first profile element.

If herein it is referred to an element, e.g. an elongate first profile element, being “attached” or “attachable” to a further element, e.g. a second profile element, it is to be understood that said further element is, preferably, also “attached” or “attachable” to said first element. For example, where an elongate first profile element is formed to be attachable at at least one of its end face, preferably its first end face, to said or one particular second profile element, wherein said at least one particular second profile element is selectable and/or m selected from a plurality of said second profile elements, said plurality of said second profile elements comprises second profile elements which are formed to be attachable to said at least one of the end face, preferably first end face, of said elongate first profile element. In an embodiment said plurality of second profile elements consists of second profile elements which are formed to be attachable to a first and/or a second end face of an elongate first profile element.

Preferably, in the manufacturing process, such first profile element is attached and common to all door structures and types of doors, which may be adapted to the desired door structure by choosing an appropriate second profile element from a plurality of said second profile elements.

A person skilled in the art will immediately acknowledge that such modular profile system and/or door suspension according to the present invention is advantageous over known door structures of the prior art, as the known door structure requires for each type of door a specific and particular design and configuration, and, moreover, specific tools.

The modular profile system and/or door suspension according to the present invention also provides several opportunities to adjust and/or vary the shape, style and/or finishing of such door and thus advantageously allows for an increase of differentiation of the doors.

In a preferred embodiment of the modular profile system and/or the door suspension according to the present invention, a door comprises a skin, wherein said skin essentially is of aesthetic purpose. Such skin, preferably an external skin, is arranged such that it is visible to the user of the kitchen appliance. Said skin, preferably is made out of aluminium, e.g. an aluminium profile, steel, e.g. a steel sheet, or plastic, e.g. a plastic component, or a combination thereof. Thus, a door with different combinations of finishing, colours, materials and shapes may be easily assembled, adapted and/or provided. In accordance therewith, it is to be understood that the modular profile system and/or the door suspension system according to the present invention, particularly comprising at least one elongate first profile element, at least one particular second profile element, and at least one panel element provides for a framework structure of a door, whereby such skin provides the surface element being visible to the costumer and being mounted onto the framework structure.

With the modular profile system and/or door suspension according to the present invention different door finishings, covers or skins, comprising elements of different materials and/or colour are made possible in a modular system and thus allow for an easy adaptation and exchange of parts, and thus an easy adaptation to the desired configuration, shape, colour composition and the like. Moreover, different external shapes of a door with regard to a skin, particularly an external skin, and/or cover, and/or the desired material, e.g. aluminium, steel or plastic, can be applied. The modular profile system according to the present invention also provides the possibility to create different external shapes and colours of the door and/or door structures, which preferably depend on the appliance and/or the door it is used for. Such different external shapes and colours may be realized by attaching skins or covers onto the internal door structure. This means, that the same internal door structure can be used for appliances of different perceived qualities and prices.

With the modular profile system and/or door suspension according to the present invention it is thus possible to generate various aesthetic and/or optical appearance based on the same framework structure which also allows to change the optical appearance in an easy manner, in that, for example, the skin is changed or adjusted according to the desired optical appearance of the kitchen appliance. Thereby, it is possible that a modular profile system and/or door suspension according to the present invention is suitable to advantageously allow its flexible use and adjustment to and between different platforms of kitchen appliances, e.g. the application of the modular profile system and/or door suspension as such is independent from the height and/or hinge concept of a kitchen appliance, as the various elements of the modular profile system and/or door suspension according to the present invention are advantageously applicable independent from said varying parameters.

A panel element may be manufactured from various materials and said material may be selected dependent on the intended purpose. As used herein, a panel element is preferably manufactured from materials selected from the group comprising glass, plastic or metal. It will be understood that where the kitchen appliance is an appliance for cooking food, such as an oven or a microwave, glass panel element is preferred, as such glass panel element allows to inspect the food stuff to be cooked without opening the door.

An at least one elongate first profile element according to the present invention is formed to be attachable at its first longitudinal plane to a surface of a first panel element. Therefore, an elongate profile element as used herein, preferably is of an oblonged shape and comprises at least one plane side, which preferably is a longitudinal plane side.

In connection therewith it will be understood that such at least one elongate first profile element may have various forms, and more particularly, various cross-sections. In a preferred embodiment such at least one elongate first profile element is an elongate profile, e.g. of C-, L or U-shaped cross-section, wherein the base of the “C”, “L” or “U”, preferably forms its first longitudinal plane. However, it is also possible to have other configurations. For example, alternatively on of or the upright sides of the “C”, “L” or “U” may form the first longitudinal plane of the at least one elongate first profile element. In a further preferred embodiment a first longitudinal plane of the elongate first profile element is laid flat on the surface of said panel element and the at least one elongate first profile element is thus attached to the panel element.

It will be understood that such at least one elongate first profile element may be positioned on the glass plate according to the intended purpose in various directions and orientation, however, an orientation parallel to at least one edge, e.g. a lateral edge or an upper or a lower edge, of the panel element is preferred. More preferably, the at least one elongate first profile element is to be oriented and positioned in parallel to an edge of the panel element which, in its mounted position in or on the door is in upright substantially vertical orientation. Preferably, the at least one elongate first profile element is to be oriented and positioned in parallel to a lateral edge of the panel element. In other words, the at least one elongate first profile element is arranged such that one end face is oriented towards the bottom of the kitchen appliance and the other end face is oriented towards an upper surface of such kitchen appliance. Preferably, the first end face of the at least one elongate first profile element is oriented towards the bottom of the kitchen appliance. In such case, it will be understood that also a second profile element attached to the first end face of such at least one elongate first profile element is oriented towards the bottom of the kitchen appliance, whereas a further second profile element attached to the second end face of such at least one elongate first profile element is oriented towards the top of the kitchen appliance.

A surface of a panel element as used herein, preferably refers to a surface of a panel element which is facing towards an inner compartment of a kitchen appliance. Preferably, said surface of said first panel element is a surface facing towards a cavity or interior compartment of the kitchen appliance, particularly, if the first panel element is in its mounted stage. Such cavity or interior compartment, preferably is a heatable cavity or interior compartment, particularly when the kitchen appliance is selected from the group comprising oven, microwave, steam oven and baking oven. It is also preferred that a panel element as used herein is a door or a part of a door. For example, a glass panel element may be a part of a glass door. For example, where the kitchen appliance is an oven, the surface of a panel element faces towards the cooking chamber. Accordingly, the at least one elongate first profile element in a mounted stage is also directed to such inner compartment.

In a preferred embodiment of the inventive modular profile system and/or the door suspension according to the present invention, the at least one elongate first profile element is formed to be attachable and/or is attached at at least one of its end face, preferably its first end face, to at least one particular second profile element, wherein said at least one particular second profile element is selectable and/or selected from a plurality of said second profile elements. It will be understood that such plurality of second profile elements comprises various forms of second profile elements with a particular configuration and shape according to the intended purpose.

In an advantageous embodiment of the inventive modular profile system and/or the door suspension according to the present invention, the at least one first profile element comprises at least one supporting element for supporting the first panel element and/or the at least one second profile element comprises at least one fixing element for fixing the position of the first panel element.

Such supporting element and/or fixing element is of particular advantage as it is for guiding and/or supporting a panel element, preferably the first panel element. A supporting element, for example may be a guiding rail or guiding slot, arranged along a longitudinal edge of the at least one first profile element. A fixing element may, for example, be a or be a part of a frame, brace, retaining bracket, cover or the like. The person skilled in the art will immediately acknowledge that various structures may be thus used as fixing element and/supporting element. For example, the supporting element may be a guiding slot into which a panel element, e.g. a glass panel is slided-in. Therefore, it is possible to provide more than one elongate first profile elements, preferably two, which allow to support the plane element at two, preferably opposing, edges. After sliding in the panel element into the at least one elongate first profile element, the second and the first profile element are assembled and attached to each other, for example by connecting means, and thereby the fixing element, preferably secures and locks the panel element in its position.

Fixing the position of a panel element preferably refers to fixing of the position relative to the modular profile system and/or the door suspension. It will be understood that after fixing of the position of the first panel element, it is preferably secured and fixed against lateral and/or horizontal movement and, more preferably, a rattling, shaking or wobbling of the panel element is advantageously avoided. Thus, the fixing element is preferably for a rattling-free, shaking-free, and/or wobbling-free fixation of the panel element, and more preferably prevents a sliding out of a supporting element.

It is, however also to be understood that such supporting element and/or fixing element may comprise further advantageous features which are considered herein. For example, where the panel element is subjected to relatively high temperature differences, e.g. the glass panel of a door of a baking oven, such supporting element and/or fixing element may comprise a flexible element which is capable of compensating variations of dimensions of the panel element, for example expansion and/or contraction due to the relatively high temperature differences occurring during heating and/or cooling down of a cooking process. A flexible element may, for example be a spring element.

In a further advantageous embodiment of the inventive modular profile system and/or the door suspension the at least one elongate first profile element, preferably at at least one of its end face, preferably its first and/or its second end face, and/or the second profile element, preferably at at least one end face, preferably its first and/or its second end face, comprises at least one first connecting means for attaching the second profile element to the at least one elongate first profile element, and/or vice versa.

Such connecting means allows to attach the second profile element to an end face, preferably the first end face of an at least one elongate first profile element, preferably detachably. Such connecting means may also be arranged at a second end face of an at least one elongate first profile element, which, preferably allows for attaching a further element at the second end face, e.g. a cover element. However, also the second profile element, preferably at an end face of the second profile element, may comprise such at least one first connecting means for attaching the second profile element to the at least one elongate first profile element.

A detachable connection may be realized via such connecting means, such detachable connection may be realized as a plug or clip connection. However, also non-detachable connections may be realized via such connecting means and combinations of non-detachable and detachable connections. For example, the second profile element may be glued or screwed to at least one of an end face, preferably the first end face, of an at least one elongate first profile element. Such connecting means may form an integral part of the second profile element and/or the at least one elongate first profile element. Alternatively, such connecting means may also be a separate part such as a bracket, hook or a double-sided engaging means.

However, it is particularly preferred herein that such connecting means forms an integral part of the second profile element and/or the at least one elongate first profile element, as this advantageously allows to reduce the number of parts needed for the inventive door suspension. In other words, connecting or attaching the second profile element to the at least one elongate first profile element via such integrally formed connecting means implies, that the inventive door suspension is basically already complete, besides an addition of e.g. a hinge or hinge element or further functional elements which also employ other functions besides the suspension of the door, e.g. a handle means or locking means.

Preferably, such connecting means are configured such that the at least one elongate first profile element is attachable to m second profile elements, wherein said second profile element is selectable and/or selected from plurality of said second profile elements and/or each of said second profile elements being selectable and/or selected from said plurality of said second profile elements is attachable to each elongate first profile element. This particularly allows to combine various second profile elements with an elongate first profile element which thus build the inventive modular profile system.

In a preferred embodiment of the inventive modular profile system and/or the door suspension the plurality of second profile elements comprises particular second profile elements of various longitudinal dimension. Accordingly, as a particular second profile element is to be attached and/or is formed to be attached to at least one of the end face, preferably the first end face, of an at least one elongate first profile element the combined at least one elongate first profile element with the particular second profile element may also vary in length. This is of particular advantage as the elongate first profile element and the particular second profile element thus form a door column which can be adjusted in length to the intended purpose.

In a further advantageous embodiment of the inventive modular profile system and/or the door suspension the at least one elongate first profile element and/or the at least one second profile element comprises at least one first mounting point for mounting at least one hinge or hinge element.

Such mounting point is advantageously used for mounting a hinge or hinge element. Such mounting point, preferably is selected from the group comprising a through hole and a receiving structure. For example, a hinge or hinge element may be screwed through such through hole or may be attached via a bolt or snap mechanism to said mounting point. Various mounting points are advantageously provided for mounting various hinges or hinge elements in an optional manner. It should be understood that not each mounting point present at the at least one elongate first profile element and/or the at least one second profile element is needed and/or used for each door configuration.

For example, the at least one elongate first profile element may comprise a mounting point for mounting a hinge or hinge element which usually is a hinge or hinge element for a swing door, opening side wards about a substantially vertical axis. However, the desired configuration is in said example to configure the door as a drop-down door, being hinged at a mounting point present at the at least one particular second profile element about a substantially horizontal axis. It is thus immediately clear that, particularly the at least one elongate first profile element will comprise such mounting point independent from the intended use, but provided for different possible door configurations. In other words, as the at least one elongate first profile element, preferably is always the same, whereas a particular second profile element is selected from a plurality of said second profile elements, the mounting points and the position thereof provided at the at least one elongate first profile element are not to be changed, but are provided according to various intended purposes and door configurations, and suitable for mounting various hinges or hinge elements. This advantageously allows the assembling of the majority of currently used hinges or hinge elements, depending on the appliance, the door is used for and its configuration. This means that the same at least one elongate first profile element may be used for various door configurations, such as a drop-down door, swing door or full door, which minimizes the number of parts, where only the appropriate second profile element is to be selected from the plurality of second profile elements and has to be used.

Accordingly, said modular profile system, and more particularly an elongated first profile element and/or a second profile element selected from a plurality of said second profile elements is/are configured such that a door can be suspended using a variety of different hinges or hinge elements, such as hinges, preferably hinges usually applied, such as hinges used for supporting a drop-down door, a side opening door, a hinge four bar mechanism, the closure for side opening and the closure push-push system or the like. For example, such hinge four bar mechanism is disclosed in EP 13198942.8 A1 and such push-push closure system is disclosed in EP 13180805.8 A1.

In a further advantageous embodiment of the inventive modular profile system and/or the door suspension, the modular profile system and/or the door suspension comprises at least one hinge or hinge element, preferably mounted to a first mounting point, wherein the at least one hinge element is for pivotal mounting of the door.

The term “hinge element” as used herein, preferably refers to an element comprising a hinge. Such hinge element may thus comprise further elements besides the hinge as such, e.g. mounting means, fixation means, e.g. screws or the like, a cover or the like.

Various hinges or hinge elements may be mounted to a single or different mounting points according to the intended purpose and/or desired door configuration. Preferably, the hinge or hinge element is selected according to the desired door configuration, wherein said door configuration is selectable from a plurality of doors and/or wherein the door is selected from the group comprising a swing door, a drop-down door and a full door, and/or wherein the hinge or hinge element, if present, allows for a pivotal movement of the door around a hinge main axis, preferably, a substantially vertical or a substantially horizontal main axis. In connection therewith, it is to be acknowledged that various forms and types of hinges or hinge elements may advantageously be assembled and used with the inventive door suspension, particularly emphasizing the modularity of the modular profile system. A person skilled in the art will know such hinges or hinge elements of various types and furthermore to adapt such hinges or hinge elements for the intended purpose, particularly to mount or adapt such hinges or hinge elements or be mountable to a first mounting point according to the present invention.

With the modular profile system according to the present invention various forms of door structures and thus doors may be easily assembled, adapted and/or provided, and particularly a first door configuration may be converted to a second configuration.

It will be understood that where the modular profile system according to the present invention is configured for supporting and/or mounting a side opening door, said side opening door may be opened and/or closed by a pivotal movement clockwise or anti-clockwise, and/or may be hinged at the left or the right side. This is particularly possible, as the elongate first profile element may comprise a mounting point for such hinge or hinge element independent of whether the elongate first profile element is arranged adjacent to a left or a right edge of the panel element.

In a further advantageous embodiment of the inventive modular profile system and/or the door suspension the door is a side opening door.

Preferably, at least one hinge or hinge element is mounted to at least one first mounting point of the at least one elongate first profile element, wherein, more preferably the door is a side opening door, for example a full door, and the at least one hinge or hinge element is for pivotal mounting of the door about an essentially vertical main axis of the hinge or hinge element.

It will be understood, by way of an example, that in case of a side opening door configuration, such as a swing door configuration or a full door configuration, the column(s) of the swing door or full door is/are basically formed by at least one, preferably two elongate first profile elements attachable at its first longitudinal plane to a surface of a first panel element, such as the surface of a panel glass element, and at at least one of the end face, preferably the first end face, of the elongate first profile elements a second profile element is to be attached which may or may not comprises a mounting point for a or hinge element typically used for a drop-down door. However, the elongate first profile elements comprise each at least one mounting point and/or may be attached to a hinge or hinge element typically used for a swing door e.g. a hinge or hinge element which in its mounted stage allows for a pivotal opening/closing movement of the door around a substantially vertical main axis of said hinge or hinge element. In such case, preferably the at least one first profile element comprises at least one further supporting element for supporting at least one further panel element and/or the at least one second profile element comprises at least one further fixing element for fixing the position of at least one further panel element. Said further panel element, preferably is an inner door, more preferably an inner glass door.

In a further advantageous embodiment of the inventive modular profile system and/or the door suspension the door is a drop-down door.

Preferably, at least one hinge or hinge element is mounted to at least one first mounting point of the at least one second profile element, wherein, more preferably, the door is a drop-down door and the at least one hinge or hinge element is for pivotal mounting of the door about an essentially horizontal main axis of the hinge or hinge element.

It will be understood, by way of an example, that in case of a drop-down door configuration, the column(s) of the drop-down door is/are basically formed by at least one, preferably two elongate first profile elements attachable at its first longitudinal plane to a surface of a first panel element, such as the surface of a panel glass element, and at at least one of the end face, preferably the first end face, of the elongate first profile elements a second profile element is to be attached which comprises and/or may be attached to a hinge or hinge element typically used for a drop-down door, e.g. a hinge or hinge element which in its mounted stage allows for a pivotal opening/closing movement of the door around a substantially horizontal main axis of said hinge or hinge element. In such case, preferably the at least one first profile element comprises at least one further supporting element for supporting at least one further panel element and/or the at least one second profile element comprises at least one further fixing element for fixing the position of at least one further panel element. Said further panel element, preferably is an inner door, more preferably an inner glass door.

In a further advantageous embodiment of the inventive modular profile system and/or the door suspension the at least one first profile element comprises at least one further supporting element for supporting at least one further panel element and/or wherein the at least one second profile element comprises at least one further fixing element for fixing the position of at least one further panel element.

The inventive modular profile system and/or the inventive door suspension, may allow mounting more than one panel element. In addition to the first panel element, which preferably is a front panel element, at least one further, e.g. one, two or three further panel elements may form part of the door. Such further panel elements are also advantageously supported by the inventive modular profile system and/or door suspension in that the at least one first profile element comprises at least one further supporting element for supporting at least one further panel element and/or

wherein the at least one second profile element comprises at least one further fixing element for fixing the position of at least one further panel element.

For example, in addition to a front glass panel, a door, preferably a door according to the present invention, may comprise a further glass panel, e.g. an inner glass panel, which is arranged substantially parallel to the first glass panel. A still further third panel element may be arranged in between a first front panel element and second inner panel element.

In a further advantageous embodiment of the inventive modular profile system and/or the door suspension the at least one elongate first profile element and/or the at least one second profile element comprises at least one second mounting point for mounting at least one functional element, preferably selected from the group comprising a locking mechanism or a part thereof, a latch means, a handle or a part thereof, a lid and an aperture, preferably an aluminium profile.

Such functional element may be of various shape, material and configuration according to the intended purpose. However, it is important to understand that such functional element as used herein has and/or supports a particular function, which is associated with a function of the kitchen appliance. Such function for example is a main function of the door of kitchen appliance, e.g. opening, closing, locking, shielding or non-shielding, particularly shielding or non-shielding temperature or view. Therefore, it is immediately clear to the person skilled in the art that a functional element as used herein, preferably is an element associated with and/or supporting said main function of the door. For example, a locking mechanism or a part thereof is associated with and supports a door locking, a latch means is associated with and supports a closing and/or locking of the door, a handle or a part thereof is associated with and supports the opening and/or closing of the door, a lid and an aperture, preferably an aluminium profile is associated with and supports the shielding or view of the door. For example a lid or an aperture may be arranged to cover or hide a hinge or hinge element. Such lid or aperture may be manufactured from various materials, for example can be an aluminium profile or steel sheet or a plastic component. Particularly, an aluminium profile is considered herein having aesthetic function and is configured and arranged to shield structural elements of the door suspension, e.g. a profile, from the view of the user. Accordingly such further functional elements may also be in addition or solely for aesthetic purposes, so as to provide a door with different combinations of finishing, colours, materials, skins and shapes.

In a further advantageous embodiment of the inventive modular profile system and/or the door suspension, the inventive modular profile system and/or the door suspension further comprises at least one cover element, wherein, preferably, the at least one elongate first profile element is formed to be attachable to said at least one cover element.

Such cover element advantageously prevents a panel glass element from slipping or sliding out of its support, particularly if the cover is arranged such that the panel element is fixed in its intended position. It is to be understood that such cover may be applied in addition to or alternatively to a fixing element. Such cover is of particular advantage if it is configured and arranged such that a panel element, particularly a glass panel, is fixed and the cover is detachably mounted to the modular profile system and/or the door suspension. The cover may easily be detached and removed, which allows for a facilitated removal of the glass panel, which, for example, allows an easy cleaning or exchange of the panel element(s).

It is to be understood that the at least one elongate first profile element at both of its end faces allows for the attachment of further elements. For example, at its first end face said second profile element is to be attached. At its second end surface, preferably a further element of the modular profile system may be attached, for example a cover.

Such cover may also at one end be attached to a second end face of a first elongate first profile element and at its second end be attached to a second end face of a second elongate first profile element, thus serving as a connecting element, connecting said first elongate first profile element with the second elongate first profile element. This, advantageously provides a frame comprising said cover element and the first and second elongate first profile element, said frame advantageously supporting the panel element.

The connection of the cover with an elongate first profile element, preferably a second end face thereof, may be same, similar or different to the connection of the at least one elongate first profile element with the second profile element, i.e. the cover or the elongate first profile element may comprise a connecting means for connecting the cover with the elongate first profile element, as essentially described in connection with the connection of the at least one elongate first profile element with the second profile element

In a further advantageous embodiment the inventive modular profile system and/or the door suspension, the modular profile system and/or the door suspension further comprises a receiving for receiving electronic components.

Electronic components as used herein, preferably comprise electronic wiring or electronic modules.

Such electronic components and/or receiving are/is preferably arranged in and/or under a cover element, if present.

Preferably, in embodiments where such electronic components and receiving are present, the door is a full door.

Such receiving is advantageous in that electrical parts such as wires or modules or further electrical components may be stored or housed therein and/or protected from dirt, steam and/or mechanical damage. Such receiving may comprise a housing. Such receiving and/or housing may also comprise a sealing element.

In a further advantageous embodiment the inventive modular profile system and/or the door suspension, the at least one elongate first profile element comprises at least one second connecting means for attachment of the at least one elongate first profile element to the surface of the first panel element.

The at least one elongate first profile element is to be attached at its first longitudinal plane to the surface of the first panel element. This preferably is achieved by a laying a flat first longitudinal plane, e.g. a basis of an at least one elongate first profile element, e.g. of C-, L or U-shaped cross-section, wherein the base of the “C”, “L” or “U”, preferably forms its first longitudinal plane, on the surface of the first panel element. The attachment of the at least one elongate first profile element to the surface of the first panel element may be detachable or non-detachable. For example, the first longitudinal plane of an at least one elongate first profile element may be directly on the surface of the first panel element. However, also other possibilities of attaching at least one elongate first profile element to the surface of the first panel element are possible and considered herein, comprising direct or indirect attachment. Such second connecting means thereby may or may not form an integral part of an at least one elongate first profile element or a first panel element. Such second connecting means may be of various form, comprising glue or adhesive, an angle, a profile or the like, a screwing, riveting, latching or clicking connection.

In connection therewith it will be understood that the way of attaching the at least one elongate first profile element to the surface of the first panel element is important for the configuration and orientation of the at least one elongate first profile element relative to the first panel element. However, the configuration of the door and/or hinges or hinge elements, preferably, is mainly independent therefrom. Accordingly, the second profile elements out of the plurality of said second profile elements is attached to at least one of the end face, preferably the first end face, of the at least one elongate first profile element mainly independent from the choice of an at least one second connecting means for attaching the at least one elongate first profile element to the surface of the first panel element.

The above described problems are also advantageously solved by a door for a kitchen appliance according to claim 13.

Such door for a kitchen appliance, comprises a modular system or parts thereof for suspending the door, wherein the modular system, preferably, is a modular system according to the present invention.

Such door may be any kind of door usually applied to kitchen appliances, and preferably selected from the group comprising substantially vertically and substantially horizontally hinged doors.

A door as used herein, preferably is selected from the group comprising swing door, full door, French door, door comprising two door wings, and drop-down door.

The above described problems are also advantageously solved by a kitchen appliance according to claim 14.

Such kitchen appliance, comprises a door, wherein

the door preferably is a door according to the present invention and/or wherein the kitchen appliance comprises a modular system or parts thereof for suspending a door of the kitchen appliance, the modular system, preferably, being a modular system according to the present invention.

In accordance with the various aspects and embodiments of the present invention a kitchen appliance as used herein, preferably is selected from the group comprising freezer, refrigerator, dishwasher, and cooking appliances, wherein a cooking appliance, preferably is selected from the group comprising oven, microwave, steam oven and baking oven.

The above described problems are also advantageously solved by a profile elements for a door of a kitchen appliance according to claim 15.

Such profile element for a door of a kitchen appliance, is an elongate first profile element according to the present invention, and/or the profile element is a second profile element according to the present invention, and/or the door is a door according to the present invention, and/or the kitchen appliance is a kitchen appliance according to the present invention.

It will be immediately understood that such profile element may also be provided as a supply part, useful particularly for an assembly worker or end user. Providing such profile element, and particularly a plurality of particular second profile elements also provides a broad range of possibilities to realize various door structure configurations. This is of particular advantage as the variation of the door structure configuration, and the assembly or change of doors and its configuration is allowed at the end of the manufacturing and/or assembly process and, preferably such adaption and/or change of the door structure configuration may be performed by the manufacturer, the assembly worker and/or the end user.

For example, a set of particular second profile elements may be delivered together with the door and preassembled elongate first profile elements and according to the users wish, the door may be configured to open sideways, left or right angled, or drop-down. According to the user's choice appropriate second profile elements have to be chosen and attached, the hinges or hinge elements have to be attached accordingly, and, the door has to be mounted to the kitchen appliance. Thus the door structure configuration can be easily adapted to the needs and wishes of the end-user.

All described embodiments of the invention have the advantage, that the overall door configuration of a door of a kitchen appliance may be easily changed and/or adapted to the desired purls pose, e.g. from mounting of a hinge or hinge element for a drop-down door to a side opening door configuration. Moreover, a modular profile system and/or a door suspension according to the present invention allows for an easy and cost efficient pre-assembling process, wherein the door configuration at the end of such manufacturing and assembling process may be easily adjusted the wishes and needs of the user. A person skilled in the art will immediately acknowledge that such modular profile system and/or door suspension according to the present invention is also advantageous over known door structures of the prior art, as the known door structure requires for each type of door a specific and particular design and configuration, and, moreover, specific tools. The modular profile system and/or door suspension according to the present invention also provides several opportunities to adjust and/or vary the shape, style and/or finishing of such door and thus advantageously allows for an increase of differentiation of the doors. With the modular profile system according to the present invention different door finishings, comprising elements of different materials and/or colour are made possible in a modular system and thus allow for an easy adaptation and exchange of parts, and thus an easy adaptation to the desired configuration, shape, colour composition and the like. Moreover, different external shapes of a door with regard to a skin, particularly an external skin, and/or cover, and/or the desired material, e.g. aluminium, steel or plastic can be applied. The modular profile system according to the present invention also provides the possibility to create different external shapes and colours of the door and/or door structures, which preferably depend on the appliance and/or the door it is used for. Such different external shapes and colours may be realized by attaching skins or covers onto the internal door structure. This means, that the same internal door structure are usable for appliances of different perceived qualities and prices.

The present invention will be described in further detail with reference to the drawings from which further features, embodiments and advantages may be taken, and in which

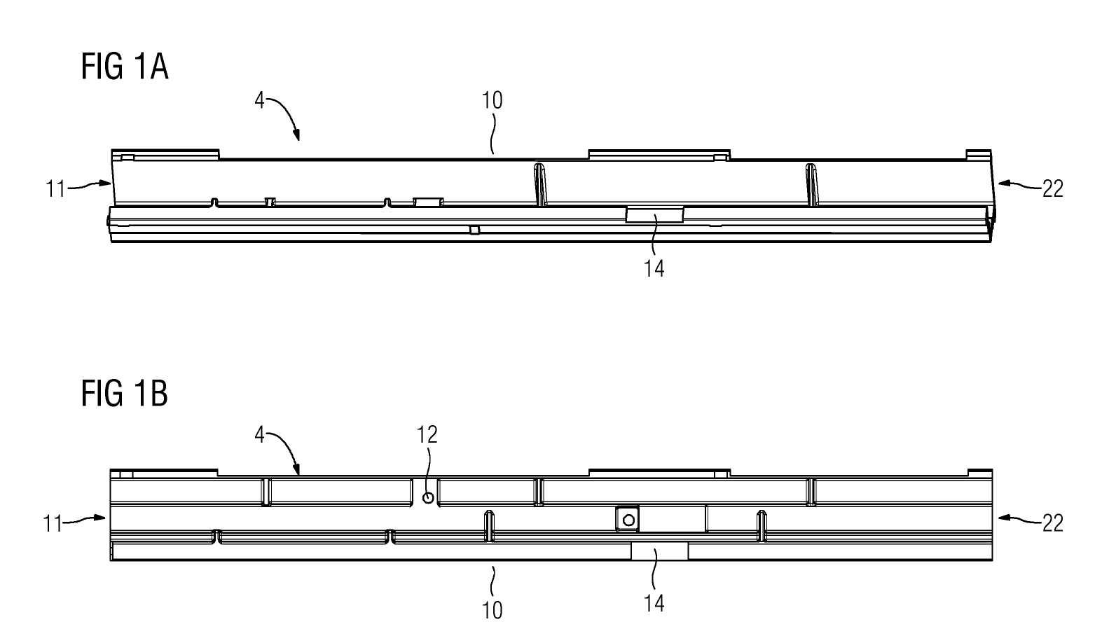

FIGS. 1A and 1B illustrate two perspective views of an elongate first profile element showing a first inventive embodiment;

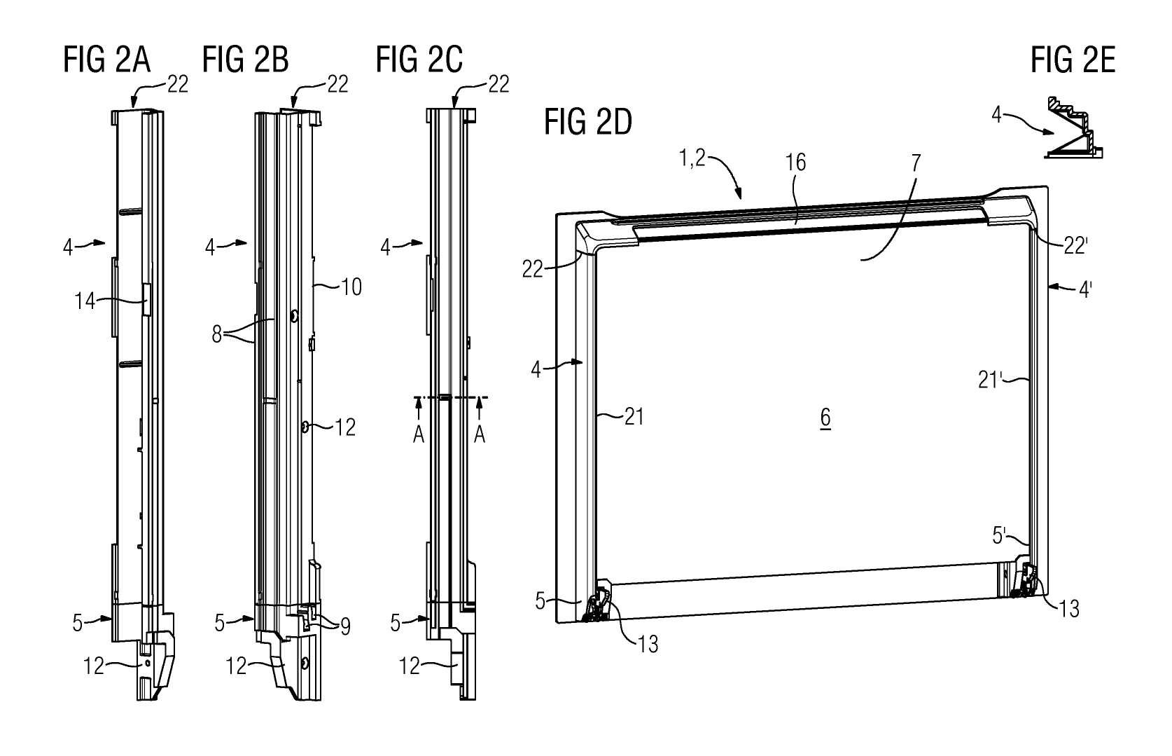

FIGS. 2A, 2B and 2C illustrate perspective views of an elongate first profile element according to the first inventive embodiment attached to a second profile element showing a second inventive embodiment;

FIG. 2D illustrate a perspective view of a modular profile system for suspending a drop-down door configuration comprising an elongate first profile element attached to a second profile element according to the second inventive embodiment;

FIG. 2E illustrates a cross-sectional view of an elongate first profile element along a line A-A of FIG. 2D;

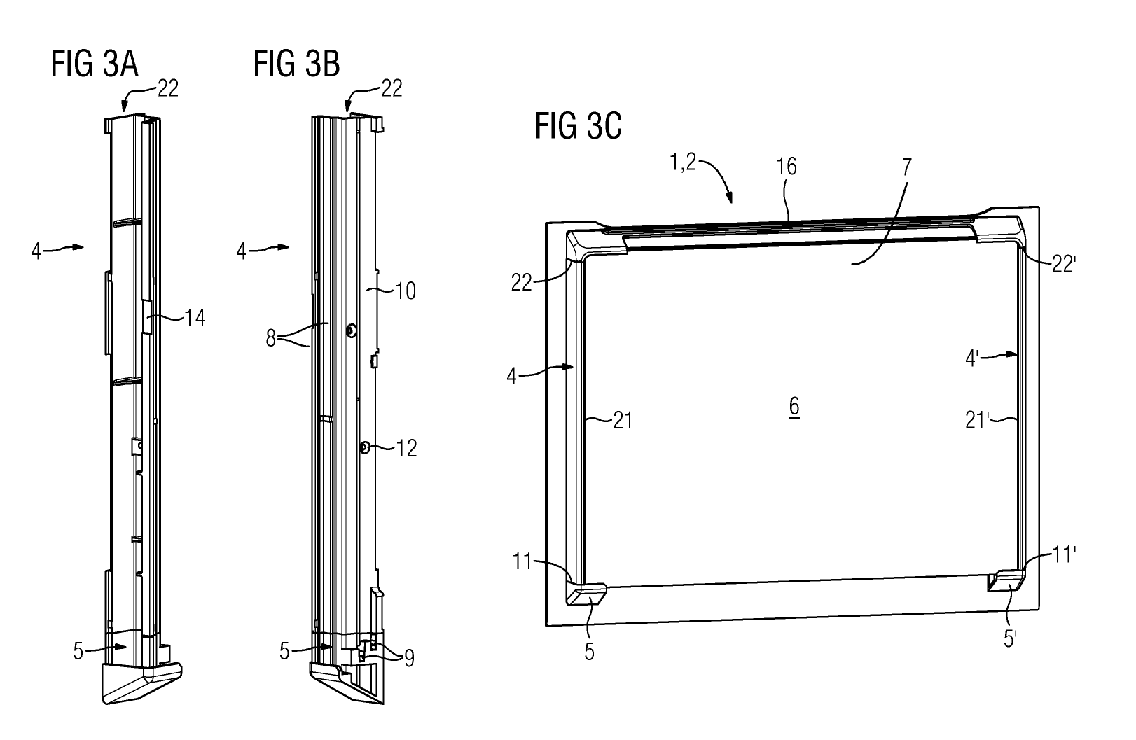

FIGS. 3A and 3B illustrate two perspective views of an elongate first profile element according to the first inventive embodiment attached to a second profile element showing a third inventive embodiment;

FIG. 3C illustrate a perspective view of a modular profile system for suspending a side opening swing door configuration comprising an elongate first profile element attached to a second profile element according to the third inventive embodiment;

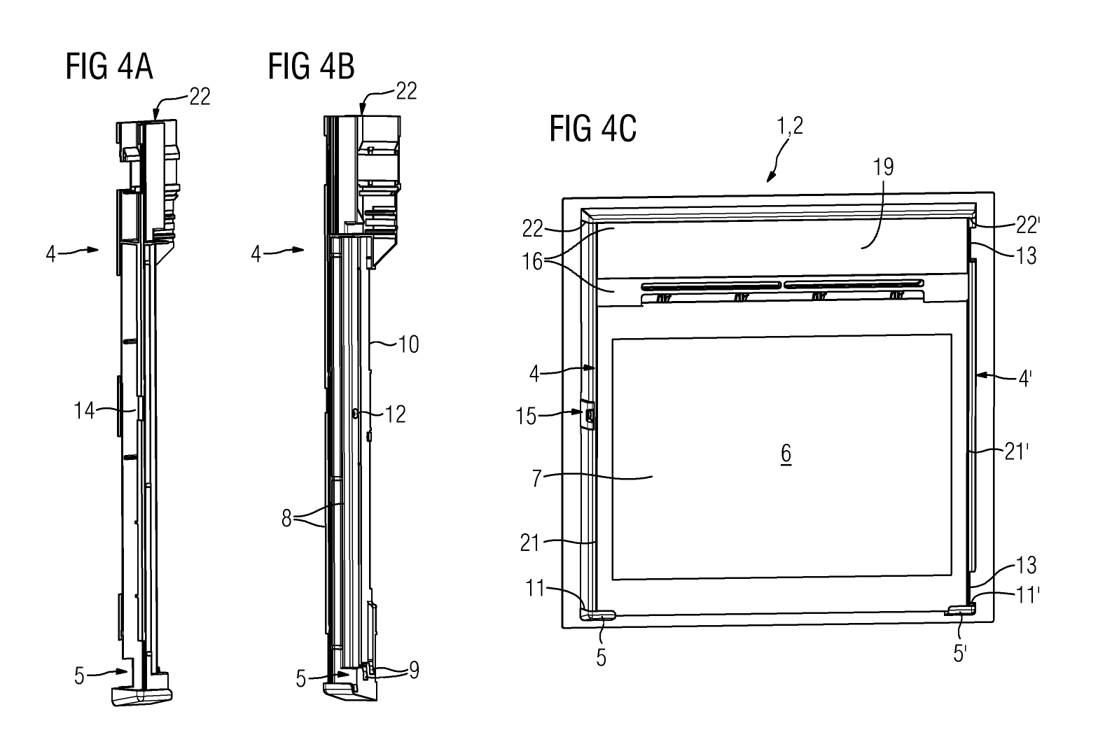

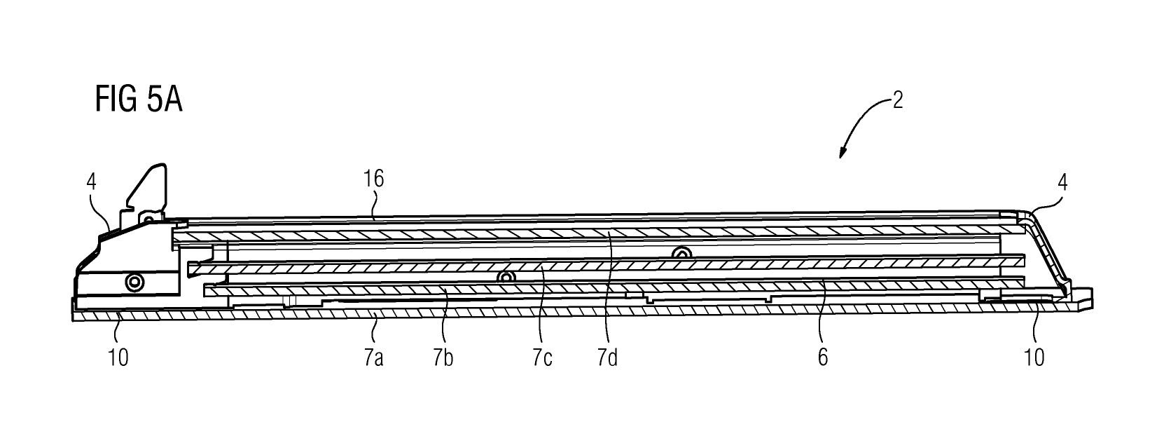

FIGS. 4A and 4B illustrate two perspective views of an elongate first profile element according to the first inventive embodiment attached to a second profile element showing a fourth inventive embodiment;

FIG. 4C illustrate a perspective view of a modular profile system for suspending a side opening full door configuration comprising an elongate first profile element attached to a second profile element according to the fourth inventive embodiment;

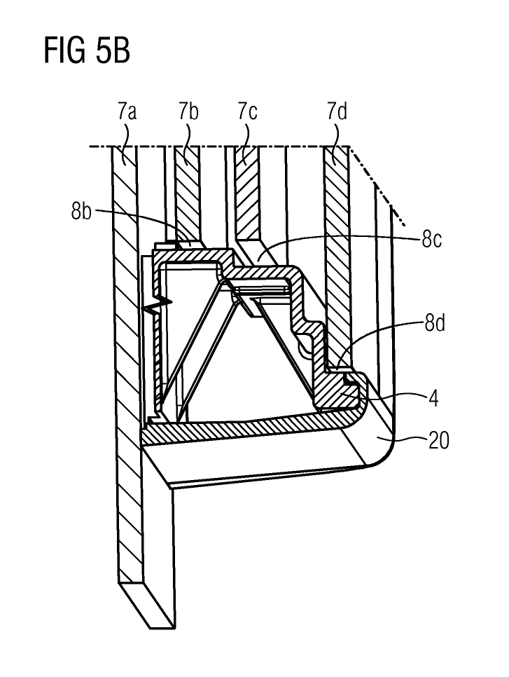

FIG. 5A illustrates a perspective view of a modular profile system for suspending a door comprising three planar glass elements and comprising an elongate first profile element according to a fifth inventive embodiment; and

FIG. 5B illustrates a perspective detail view of the modular profile system according to the fifth inventive embodiment.

In FIGS. 1A and 1B two perspective views of an elongate first profile element 4 are shown which is to be used in connection with the modular profile system 1 according to the present invention for suspending a door 2 of a kitchen appliance 3. In FIGS. 1A and 1B the door 2 and the kitchen appliance 3 are not shown. Said elongate first profile element 4 as shown in FIGS. 1A and 1B may be applied for various door configurations as part of the modular profile system 1 according to the present invention attached to at least one particular second profile element being selectable and/or selected from a plurality of second profile elements 5.

Therefore, the first profile element 4 may comprise one or several mounting points 12 for various hinges or hinge elements 13, and/or at least one second mounting point 14 for mounting at least one further function element 15. The first profile element 4 is formed to be attachable (see also FIGS. 2A, 2B, 2C, 3A, 3B, 4A, and 4B) or is attached (see FIGS. 2D, 3C, 4C, and 5A) at its first longitudinal plane 10 to a surface 6 of a first panel element 7 or 7a (not shown in FIGS. 1A and 1B), and wherein the elongate first profile elements 4 is formed to be attachable (see FIGS. 2A, 2B, 2C, 3A, 3B, 4A, and 4B) or is attached (see FIGS. 2D, 3C, and 4C) at its first end face 11 each to a particular second profile element 5 selected from a plurality of said second profile elements 5 according to the desired door configuration.

It is to be understood that also the second end face 22 of the first elongate first profile element 4 may be attached to either a second profile element 5 or to a cap or cover 16. As may be immediately taken from the FIGS. 2D and 3C, such cover 16 is at one end be attached to a second end face 22 of the first elongate first profile element 4 and at its second end is attached to the second end face 22′ of a second elongate first profile element 4′, thus serving as a connecting element, connecting said first elongate first profile elements 4 and 4′, more particularly said second end faces 22 and 22′.

This may be taken from FIGS. 2A, 2B, 2C and 2D which illustrate a modular profile system 1 and/or parts thereof assembled and selected for suspending a drop-down door configuration compared to FIGS. 3A, 3B and 3C which illustrate a modular profile system 1 and/or parts thereof assembled and selected for suspending a side opening swing door configuration, compared to FIGS. 4A, 4B and 4C which illustrate a modular profile system 1 and/or parts thereof assembled and selected for suspending a side opening swing door configuration. Each modular profile system 1 comprises at least one, preferably two, elongate first profile element 4 or 4′ according to the first inventive embodiment shown in FIGS. 1A and 1B, being attachable to or attached to an appropriate second profile element 5 selected and/or selectable from a plurality of second profile elements. It is to be understood that two first profile elements 4 and 4′ may be configured identical or mirror-inverted to each other depending on the specific needs and configuration, e.g. positioning of mounting points 12 and/or 14. In a particular preferred embodiment a first profile element 4 according to the present invention is configured such that it can be mounted to a surface 6 of a first panel element 7 or 7a in two orientations which are oriented at 180° to one another, whereby, preferably the positioning of mounting points 12 and/or 14, as well as the configuration of the end faces 11 and 22 is configured accordingly.

Each modular profile system 1 as particularly shown in FIGS. 2D, 3C and 4C in a stage where elongate first profile elements 4 are mounted with the first longitudinal plane 10 to a surface 6 of a first panel element 7 or 7a comprises two of said elongate first profile elements 4, 4′, each attached to a particular second profile element 5 or 5′ selected according to the intended purpose. Again, it will immediately be understood that depending on the specific needs and configuration, for example the intended hinges or hinge elements and/or door configuration, the second profile elements 5 or 5′ may be configured identical or mirror-inverted to each other.

According to the embodiment shown in FIGS. 2A, 2B, 2C and 2D for suspending a drop-down door 2; according to the embodiment shown in FIGS. 3A, 3B and 3C for suspending a side opening swing door 2; and according to the embodiment shown in FIGS. 4A, 4B and 4C for suspending a side opening full door, each modular profile system 1 in its mounted stage ready to be hinged to an according kitchen appliance 3 as shown in FIGS. 2D, 3C, and 4C, respectively, further comprises at least one panel element 7, wherein according to the embodiment shown in FIGS. 5A and 5B a door may provided having more than one panel element, particularly having four panel elements 7a, 7b, 7c, and 7d. Thereby, the elongate first profile elements 4 and 4′ are formed to be attachable (see particularly FIGS. 2A, 2B, 2C, 3A, 3B, 4A, and 4B) or are attached (see FIGS. 2D, 3C, 4C, and 5A) at their first longitudinal plane 10 to the surface 6 of a first panel element 7 or 7a, and wherein the elongate first profile elements 4 and 4′ are formed to be attachable (see FIGS. 2A, 2B, 2C, 3A, 3B, 4A, and 4B) or are attached (see FIGS. 2D, 3C, and 4C) at their first end face 11 each to a particular second profile element 5 or 5′ selected from a plurality of said second profile elements 5, 5′ according to the desired door configuration.

Thereby, and as may be best seen from FIGS. 2D, 3C, and 4C two elongate first profile elements 4 and 4′ are attached with their with the first longitudinal plane 10 to a surface 6 of a first panel element 7 or 7a such, that said profile elements 4 and 4′ are positioned on the glass plate 7 according to the intended purpose in an orientation parallel to the opposing side edges 21 and 21′, respectively, of the glass plate 7. More particularly, the elongate first profile elements 4 and 4′ are oriented and positioned in parallel to the side edges 21 and 21′ of the glass plate 7, which, in a mounted position in or on the door is in upright substantially vertical orientation. In the embodiments shown here, for example as shown in FIGS. 2D, 3C, and 4C, the elongate first profile elements 4 and 4′ are positioned in a manner mirror-inverted to each other on the glass plate 7. Accordingly, also the second profile element 5, which is attached to the first end face 11 of an elongate first profile element 4 is configured mirror-inverted to the second profile element 5′, which is attached to the first end face 11′ of an elongate first profile element 4′.

In other words, the elongate first profile elements 4 are arranged such that one first end 11 faces towards the bottom of the oven 3 and the second end face 22 is oriented towards an upper surface of the oven 3, preferably in a configuration being mirror-inverted to each other. Here it is immediately clear that the when the second profile element 5 or 5′ is attached to the first end face 11 or 11′, respectively, of an elongate first profile element 4 or 4′, respectively, said second profile element 5 or 5′, respectively, is also oriented towards the bottom of the oven 3. From the door configurations shown in FIGS. 2D, 3C, and 4C, it is also immediately clear that here the surface 6 of the glass plate 7 refers to the surface 6 of the glass plate 7 which is facing towards an inner compartment of the oven 3. Accordingly, in a stage where the door 2 is mounted to the oven 3, the elongate first profile elements 4 and 4′, respectively, are also directed to an inner compartment, i.e. the oven cavity, of said kitchen appliance 3.

However, also more than one panel element 7 may be advantageously applied as already indicated above. Referring in so far to the embodiment of the door 2 according to the present invention, and the modular profile system 1 according to the present invention as shown in FIG. 5a and FIG. 5B, it can be immediately seen that the elongate first profile elements 4 or 4′, respectively, are attached at their first longitudinal plane 10 to the surface 6 of the first panel element 7a. In connection therewith, it is to be understood that in the embodiment shown here, panel element 7a is glass panel, which may be configured with or without metal trim. However, the elongate first profile elements 4 or 4′, respectively, are configured such that three further panel elements 7b, 7c, and 7d, are supported, particularly by the configuration of the basically C-shaped cross-section of the elongate first profile elements 4 and 4′, respectively, which comprises bend sections 8b, 8c, and 8d each configured to support a further panel element 7b, 7c, or 7d, respectively, as a supporting element 8.

Such modular profile system 1 allows to create a modular door 2 and/or door structure that can be used for all different types of doors in that each configuration and set of elongate first profile elements 4 and 4′, respectively, and second profile elements 5 and 5′, respectively, as well as, preferably the intended hinges or hinge elements and further elements provides one particular door suspension, which may be best seen when comparing FIG. 3C for the purpose of realizing a side opening door, here a swing door, FIG. 4C for the purpose of realizing a side opening door, here a full door, FIG. 2D for the purpose of realizing a drop-down door, and FIG. 5A showing a door 2 with more than one panel element 7. Each desired door structure and door suspension to be realized, is thereby advantageously based on and realized with the modular profile system 1, and more particularly with the elongate first profile elements 4, and 4′, respectively, being attachable at its first longitudinal plane 10 to the surface 6 of a first panel element 7, as for example shown in FIGS. 1A and 1B the surface of a planar glass panel. The elongate first profile element 4 is also attachable or attached to, at its first end face 11 to at least one particular second profile element 5, or 5′ respectively, selected from a plurality of said second profile elements 5 and 5′, respectively, according to the desired purpose and door configuration, i.e. according to the embodiment shown in FIG. 2D a drop-down door, according to the embodiment shown in FIG. 3C a swing door, and according to the embodiment shown in FIG. 4C a full door. The particular second profile elements 5 and 5′, respectively, are configured in various ways according to the desired purpose and door configuration. According to the embodiment shown in FIGS. 2A, 2B and 2C for a pivotally hinged door about a horizontal axis, i.e. for a drop-down door; and according to the embodiments shown in FIGS. 3A and 3B, or 4A and 4b, respectively, for a pivotally hinged door about a vertical axis, i.e. for a side opening door. Accordingly, the shape and further elements such as mounting points 12 for hinges or hinge elements 13 are present or not present at such particular second profile elements 5 or 5′, respectively. For example, it may be seen that according to the embodiment shown in FIGS. 2A, 2B, 2C and 2D the particular second profile elements 5 or 5′, respectively, comprises at least one first mounting point 12, here a through hole, e.g. for mounting a drop-down hinge 13, as may be best seen in FIG. 2D. By contrast, the particular second profile elements 5 or 5′, respectively shown in FIGS. 3A, 3B, and 3C, or FIGS. 4A, 4B, and 4C, does not comprise such first mounting point 12, as said configuration is intended to provide a door suspension and door structure for a side opening door 2. It has to be understood that advantageously in the manufacturing and/or assembly process, such first profile element 4 or 4′, respectively, as shown here is advantageously attached and common to all door structures and types of doors, which may be adapted to the desired door structure by choosing an appropriate/particular second profile element 5 or 5′, respectively, from a plurality of said second profile elements. Here the door 2 comprises a skin 20, which may be best seen in FIG. 5B, wherein said skin 20 is mainly for aesthetic purpose. Such skin 20, here an external skin 20, is arranged such that it is visible to the user of the kitchen appliance 3. Said skin 20 is preferably made out of aluminium, more precisely being an aluminium profile.

Here, in all shown embodiments, the door 2 is a door of an oven 3. The elongate first profile elements 4 or 4′, respectively, is an elongate profile of substantially C-shaped cross-section wherein the base of the “C” forms its first longitudinal plane 10. This may be best seen in FIG. 2E showing the cross-sectional view of the elongate first profile element 4 along the line A-A of FIG. 2C. In order to attach the elongate first profile element 4 or 4′, respectively, to a glass panel 7 the first longitudinal plane 10 of the elongate first profile element 4 or 4′, respectively, is, for example provided with an adhesive, laid flat and glued on the surface 6 of the planar glass plate 7 and the elongate first profile element 4 is thus attached to the glass plate 7.

The first profile elements 4 or 4′, respectively, as shown here, also comprise guiding slots as supporting elements 8 for supporting the front glass plate 7 or other panel elements (as shown, e.g. in FIGS. 5A and 5B) and arranged along a longitudinal edge of the first profile element 4. The second profile elements 5 or 5′, respectively, further comprises frame supports in the form of slots for glass panels, as fixing elements 9 for fixing the position of the panel elements 7. Also it may be taken from the different embodiments shown in the hereto attached Figures, that the elongate first profile element 4 or 4′, respectively, comprises several first mounting points 12 for mounting hinges or hinge elements 13. As may be best seen from FIGS. 2A, 2B and 2C only in the embodiment for suspending a drop-down door the second profile element 5 or 5′, respectively, may comprise first mounting points 12 for mounting hinges or hinge elements 13, here a drop-down hinge 13. As may be taken from FIGS. 3A and 3B, and from 4A and 4B, in the embodiment for suspending a side opening door, i.e. a full door or a swing door, the particular second profile element 5 or 5′, respectively, is chosen from the plurality of second profile elements, for example, such that it does not comprise such first mounting points 12 as no hinges or hinge elements 13 are to be mounted at the second profile element 5 or 5′, respectively. However, the mounting points 12, present at the elongate first profile elements 4 or 4′, respectively, and, optionally on the second profile element 5 or 5′, respectively, are advantageously used for mounting a hinge or hinge element 13. Such mounting point 12, preferably is configured as a receiving structure 23 for receiving such hinge or hinge element 13. In FIG. 4C the hinge or hinge element is, for example a four bar hinge 13. Various mounting points are advantageously provided for mounting various hinges or hinge elements in an optional manner. It is to be understood that not each mounting point 12 present at the first profile element 4 or 4′, respectively, or the second profile element 5 or 5′, respectively, is needed for each door configuration. For example, in the configuration shown in FIG. 2B each profile element, i.e. the elongate first profile element 4 or 4′, respectively, and the second profile element 5 or 5′, respectively, each comprise a first mounting point 12, suitable to apply the drop-down hinges 13.

For example, the elongate first profile element 4 or 4′, respectively, as shown, for example, in FIGS. 4A and 4B may comprise a mounting point 12 for mounting a hinge or hinge element, e.g. drop-down hinge. However, the desired configuration in said example, is to configure the door 2 as a side-opening door, being hinged at a four bar hinge 13 the door to be opened about a substantially vertical axis. In connection therewith, it is thus immediately clear that, particularly the elongate first profile elements 4 or 4′, respectively, may comprise such mounting points 12 independent from the intended use, but provided for different possible door configurations. In other words, as the at least one elongate first profile element is preferably the same in all embodiments the second profile element 5 shown in FIGS. 2A, 2B, 2C, and 2D is different from the second profile element 5 shown in FIGS. 3A, 3B and 3C, and is also different from the second profile element 5 shown in FIGS. 4A, 4B and 4C. Each of said particular second profile elements 5 or 5′, respectively, is selected from a plurality of second profile elements, the mounting points 12 and the position thereof provided at the elongate first profile element 4 or 4′, respectively, are not to be changed, but are provided according to various intended purposes and door configurations, and suitable for mounting various hinges or hinge elements 13.

Here the elongate first profile elements 4 or 4′, respectively, at its first end face 11 and 11′, respectively, and the second profile elements 5 or 5′, respectively, each comprise at least one first connecting means 17 for attaching the elongate first profile element 4 or 4′, respectively, to the second profile element 5 or 5′, respectively.

Various hinges or hinge elements 13 may be mounted to a single or different mounting points 12 according to the intended purpose and/or desired door configuration. Thereby a hinge or hinge element 13 suitable for the desired door configuration is mounted to a first mounting point 12, wherein the hinge element 13 is for pivotal mounting of the door 2.

According to the embodiment shown in FIGS. 3C, and 4C where the desired door configuration is a side opening door configuration, i.e. a swing door configuration as shown in FIG. 3C or a full door configuration as shown in FIG. 4C, the column(s) of the swing door or full door are basically formed by two elongate first profile elements 4 and 4′, each attached at their first longitudinal planes 10 to the surface 6 of the front glass panel 7, and at the first end face 11 or 11′, respectively, of the elongate first profile elements 4 or 4′, respectively, a particular second profile element 5 and 5′, respectively is attached, which in this case does not comprises a mounting point 12 for a hinge or hinge element 13 typically used for a drop-down door. However, the elongate first profile elements 4 or 4′, respectively, comprise each at least one mounting point 12 and are attached to a hinge or hinge element 13 typically used for a swing door e.g. a hinge or hinge element 13 which in its mounted stage allows for a pivotal opening/closing movement of the door 2 around a substantially vertical main axis of said hinge or hinge element 13. Here the first profile elements 4 or 4′, respectively, comprise at least one further supporting element 8 for supporting at least one further panel element 7 and the at least one second profile elements 5 or 5′, respectively, comprise at least one further fixing element 9 for fixing the position of the at least one further panel element 7. This may be best seen in FIG. 2B or 3B. Said further panel element, preferably is an inner glass door.

As shown in FIGS. 2A, 2B, 2C and 2D in case of a drop-down door configuration, the column(s) of the drop-down door 2 are basically formed by two elongate first profile elements 4 and 4′, respectively, attached each at their first longitudinal plane 10 to the surface 6 of the front glass plate 7, and at the first end faces 11 and 11′, respectively, of the elongate first profile elements 4 or 4′, respectively, a second profile element 5 or 5′, respectively, is attached, which comprises and may be attached to a hinge or hinge element 13 typically used for a drop-down door 2, i.e. a hinge or hinge element which in its mounted stage allows for a pivotal opening/closing movement of the door 2 around a substantially horizontal main axis of said hinge or hinge element 13. In such case, the first profile elements 4 or 4′, respectively, comprise at least one further supporting element 8, 8b, 8c, 8d for supporting at least one further panel element 7b, 7c and/or 7d and the second profile elements 5 or 5′, respectively, comprises at least one further fixing element 9 for fixing the position of at least one further panel element 7. Said further panel element, preferably is an inner glass door (see particularly FIGS. 5A and 5B).

As may be seen, for example, from FIG. 4C, the elongate first profile element 4 or 4′, respectively, and/or the second profile element 5 or 5′, respectively, here elongate first profile element 4, may comprise at least one second mounting point 14 for mounting at least one further function element 15. As may be seen in FIG. 4C the functional element 15 is a latch means for closing said door 2. As may be best seen in FIG. 4A vis-à-vis FIG. 4C, the second mounting point 14 also may be configured as or comprise a cut out 14 for providing the possibility and space to attach the functional element 15, here the latch means 15, which particularly is for closure of the side opening door.

Moreover, as may be seen in FIGS. 2D and 3C an aluminium profile is provided which is mainly for aesthetic purpose, e.g. for hiding and covering the profile elements 4, 4′ and 5, 5′. Such aluminium profile may be attached to the profile elements 4, 4′ and/or 5, 5′ or may be attached to the panel element or other door parts. It may be attached to the door or parts thereof in various ways, detachably mounted or non-detachably mounted. For example, it may be attached to the profile elements using an adhesive.

As may be best seen in FIGS. 2D and 3C, the inventive modular profile system 1 further comprises a cover element 16, and the elongate first profile elements 4 and 4′ are attached to the cover element 16. The cover element 16 advantageously prevents the planar glass elements from slipping out of its support, particularly if the cover 16 is arrange such that the planar element is fixed in its intended position. As may be immediately taken from the FIGS. 2D and 3C, the cover 16 is at one end attached to a second end face 22 and 22′, respectively, of the first elongate first profile element 4 and 4′, respectively, and at its second end is attached to the second end face 22 and 22′, respectively, of a second elongate first profile element 4 and 4′, respectively, thus serving as a connecting element, connecting said first elongate first profile elements 4 and 4′. This, advantageously provides a frame comprising said cover element 16 and the first and second elongate first profile elements 4 and 4′, said frame advantageously supporting the glass plate 7.

Such cover element 16 may be attached to the profile elements 4 and 4′, respectively, and/or 5 and 5′, respectively, or may be attached to the panel element or other door parts. It may be attacked to the door or parts thereof in various ways, detachably mounted or non-detachably mounted. For example, it may be attached to the profile elements using an adhesive, however, if it is desired to easily exchange the planar element(s) or to make them easily accessible, it is preferred to detachable mount the cover element 16, for example using a plug- or clip-connection.

As may be taken from FIG. 4C, wherein the door 2 is a full door, the cover element 16 comprises a receiving 19 for receiving electronic components, such as wiring or modules. Such receiving is advantageous in that electrical parts such as wires or modules or further electrical components may be stored or housed therein and are protected from dirt, steam and/or mechanical damage.

In the shown embodiments the elongate first profile elements 4 and 4′, respectively, are directly glued onto the surface 6 of the first panel element 7, the glue thus serving as a second connecting means 18.

The features of the present invention disclosed in the specification, the claims, and/or the figures may both separately and in any combination thereof be material for realizing the invention in various forms thereof.

### LIST OF REFERENCE NUMERALS

1 modular profile system
2 door
3 kitchen appliance
4 elongate first profile element
5 second profile element
6 surface
7 panel element
8 supporting element
9 fixing element
10 first longitudinal plane
11 first end face
12 mounting point
13 hinge element
14 at least one second mounting point
15 function element
16 cover element
17 first connecting means
18 second connecting means
19 receiving
20 skin
21 side edges
22 second end face
23 receiving structure for hinge element

1. A modular profile system for suspending a door of a kitchen appliance, comprising at least one elongate first profile element, at least one second profile element, and at least one panel element, wherein the at least one elongate first profile element is formed to be attachable at its first longitudinal plane to a surface of a first panel element, and wherein the at least one elongate first profile element is formed to be attachable at at least a first end face thereof to said second profile element, wherein said second profile element is selectable from a plurality of said second profile elements, and wherein said elongate first profile element is combinable and to be assembled with at least one of said plurality of second profile elements, in order to achieve and realize one particular door structure and/or door organization.

2. The modular profile system according to claim 1, wherein the at least one elongate first profile element comprises at least one supporting element for supporting the first panel element and/or wherein the at least one second profile element comprises at least one fixing element for fixing the position of the first panel element.

3. The modular profile system according to claim 1, wherein the at least one elongate first profile element and/or the second profile element, comprises at least one first connecting means for attaching the second profile element to the at least one elongate first profile element.

4. The modular profile system according to claim 1, wherein the at least one elongate first profile element and/or the at least one second profile element comprises at least one first mounting point for mounting at least one hinge or hinge element.

5. The modular profile system according to claim 1, wherein the modular profile system comprises at least one hinge or hinge element, wherein the at least one hinge or hinge element is for pivotal mounting of the door.

6. The modular profile system according to claim 1, wherein the door is a side opening door.

7. The modular profile system according to claim 1, wherein the door is a drop-down door.

8. The modular profile system according to claim 1, wherein the at least one elongate first profile element comprises at least one further supporting element for supporting at least one further panel element and/or wherein the at least one second profile element comprises at least one further fixing element for fixing the position of at least one further panel element.

9. The modular profile system according to claim 1, wherein the at least one elongate first profile element and/or the at least one second profile element comprises at least one second mounting point for mounting at least one functional element, wherein the functional element, is selected from the group consisting of a locking mechanism or a part thereof, a latch means, a handle or a part thereof, a lid and an aperture.

10. The modular profile system according to claim 1, further comprising at least one cover element, wherein the at least one elongate first profile element is formed to be attachable to said at least one cover element.

11. The modular profile system according to claim 1, wherein the modular profile system further comprises a receiving for receiving electronic components.

12. The modular profile system according to claim 1, wherein the at least one elongate first profile element comprises at least one second connecting means for attachment of the at least one elongate first profile element to the surface of the first panel element.

13. Door for a kitchen appliance, comprising a door suspension system for suspending the door, wherein the door suspension system comprises the modular profile system according to claim 1.

14. Kitchen appliance comprising a door and a door suspension system for suspending the door of the kitchen appliance, the door suspension system comprising the modular profile system according to claim 1.

15. (canceled)

16. A modular profile system for suspending a door of a kitchen appliance, comprising first and second elongate first profile elements each having a channel-shaped cross-section, at least one second profile element, and a first panel element, wherein the first and second elongate first profile elements are attachable at planar surfaces thereof to opposite ends of the first panel element, said first and second elongate first profile elements being attachable at respective first end faces thereof to said at least one second profile element so as to oppose and be mirror images of one another at opposite sides of the door, said first and second elongate first profile elements further being attachable at respective second end faces thereof to a cover, wherein said at least one second profile element is selected from a plurality of second profile elements respectively configured for a plurality of different door-suspension configurations, said first and second elongate first profile elements comprising a plurality of hinge-mounting points to accommodate respectively said plurality of different door-suspension configurations, wherein not every such mounting point will be used in each such configuration, said plurality of different door-suspension configurations comprising a drop-down door configuration and a side opening door configuration.

17. The modular profile system according to claim 16, said at least one second profile element comprising first and second ones of said second profile element, each being attachable respective to one of said first and second elongate first profile elements at opposite sides of said door, said first and second second profile elements further comprising one or more further hinge-mounting points to accommodate one or more of said plurality of different door-suspension configurations.

18. A method of manufacturing a door for a kitchen appliance, comprising:
a. attaching first and second elongate first profile elements to opposite sides of a first panel element, said first and second elongate first profile elements comprising a plurality of hinge-mounting points to accommodate respective a plurality of different door-suspension configurations;
b. selecting one of the plurality of different door configurations;
c. selecting at least one second profile element from a plurality of available second profile elements configured to accommodate respectively said plurality of different door configurations, wherein ones of said plurality of second profile elements comprise one or more additional hinge-mounting points to accommodate respectively an associated one of said configurations;
d. attaching said at least one second profile element to said first and second elongate first profile elements at respective first end faces thereof;
e. attaching one or more hinges to ones of said hinge-mounting points that correspond to the selected one of said plurality of different door configurations.
